(19) United States
(12) Patent Application Publication
(10) Pub. No.: US 2015/0351332 A1
(43) Pub. Date: Dec. 10, 2015

(54) Sprinkler Flow Valves

(71) Applicant: The Toro Company, Bloomington, MN (US)

(72) Inventors: Peter Janku, Temecula, CA (US); Steven C. Renquist, Norco, CA (US); James Zimmerman, Norco, CA (US); Saroj Manandhar, Chino Hills, CA (US); Robert Ferry, Morongo Valley, CA (US)

(21) Appl. No.: 14/728,879

(22) Filed: Jun. 2, 2015

Related U.S. Application Data
(60) Provisional application No. 62/009,862, filed on Jun. 9, 2014.

(51) Int. Cl. A01G 25/00; B05B 1/30; B05B 15/10

(52) U.S. Cl. CPC A01G 25/00; B05B 15/10; B05B 1/3013

(57) ABSTRACT

A sprinkler assembly is disclosed, having a flow control valve accessible from an exterior of the assembly, a backflow preventer valve that prevents water and debris from being sucked into a sprinkler when water pressure stops, and a safety valve that prevents watering when the sprinkler is missing from the assembly.

### RELATED APPLICATIONS

This application claims priority to U.S. Provisional Application Ser. No. 62/009,862 filed Jun. 9, 2014 entitled Sprinkler Flow Valves, which is hereby incorporated herein by reference in its entirety.

### BACKGROUND OF THE INVENTION

Sprinkler systems for turf irrigation are well known. Typical systems include a plurality of valves and sprinkler heads in fluid communication with a water source, and a centralized controller connected to the water valves. At appropriate times the controller opens the normally closed valves to allow water to flow from the water source to the sprinkler heads. Water then issues from the sprinkler heads in a predetermined fashion.

There are many different types of sprinkler heads, including above-the-ground heads and “pop-up” heads. Pop-up sprinklers, though generally more complicated and expensive than other types of sprinklers, are thought to be superior. There are several reasons for this. For example, a pop-up sprinkler's nozzle opening is typically covered when the sprinkler is not in use and is therefore less likely to be partially or completely plugged by debris or insects. Also, when not being used, a pop-up sprinkler is entirely below the surface and out of the way.

The typical pop-up sprinkler head includes a stationary body and a “riser” which extends vertically upward, or “pops up,” when water is allowed to flow to the sprinkler. The riser is in the nature of a hollow tube which supports a nozzle at its upper end. When the normally-closed valve associated with a sprinkler opens to allow water to flow to the sprinkler, two things happen: (i) water pressure pushes against the riser to move it from its retracted to its fully extended position, and (ii) water flows axially upward through the riser, and the nozzle receives the axial flow from the riser and turns it radially to create a radial stream. A spring or other type of resilient element is interposed between the body and the riser to continuously urge the riser toward its retracted, subsurface, position, so that when water pressure is removed the riser assembly will immediately return to its retracted position.

The riser assembly of a pop-up or above-the-ground sprinkler head can remain rotationally stationary or can include a portion that rotates in continuous or oscillatory fashion to water a circular or partly circular area, respectively. More specifically, the riser of the typical rotary sprinkler includes a first portion (e.g. the riser), which does not rotate, and a second portion, (e.g. the nozzle assembly) which rotates relative to the first (non-rotating) portion.

The rotating portion of a rotary sprinkler riser typically carries a nozzle at its uppermost end. The nozzle throws at least one water stream outwardly to one side of the nozzle assembly. As the nozzle assembly rotates, the water stream travels or sweeps over the ground.

The non-rotating portion of a rotary sprinkler riser assembly typically includes a drive mechanism for rotating the nozzle. The drive mechanism generally includes a turbine and a transmission. The turbine is usually made with a series of angular vanes on a central rotating shaft that is actuated by a flow of fluid subject to pressure. The transmission consists of a reduction gear train that converts rotation of the turbine to rotation of the nozzle assembly at a speed slower than the speed of rotation of the turbine.

During use, as the initial inrush and pressurization of water enters the riser, it strikes against the vanes of the turbine causing rotation of the turbine and, in particular, the turbine shaft. Rotation of the turbine shaft, which extends into the drive housing, drives the reduction gear train that causes rotation of an output shaft located at the other end of the drive housing. Because the output shaft is attached to the nozzle assembly, the nozzle assembly is thereby rotated, but at a reduced speed that is determined by the amount of the reduction provided by the reduction gear train.

### SUMMARY OF THE INVENTION

In one embodiment of the present invention, a flow control valve is disclosed that allows the amount or rate of water flow to be easily adjusted by the user. The user can use a tool (e.g., screw driver or hex wrench) to insert into a hole in side of the sprinkler assembly and, by rotating the tool, the user rotates a horizontal cam shaft that lowers or raises a valve member to varying positions. In this respect, the amount of water passing through can be varied.

In one embodiment of the present invention, a backflow valve is disclosed that, when water pressure is turned off, immediately closes, preventing dirt, debris, and water that is at or near the top of the sprinkler from being sucked into the sprinkler. This dirt and debris would otherwise cause damage to the mechanisms of the sprinkler. The backflow valve includes a valve member that is downwardly biased against a valve seat. The biasing spring, is configured to apply enough force to maintain the valve in a closed position with little or no water pressure, and to open when sufficient water pressure is present.

In one embodiment of the present invention, a safety valve is disclosed that prevents water flow through the sprinkler assembly when a sprinkler is broken, damaged, or otherwise not present. The safety valve includes an elongated valve member that is pushed to a downward, open configuration by the bottom of either a sprinkler or an elongated sprinkler cap. If the sprinkler or cap is otherwise missing, water pressure pushes the valve member upwards so as to close the valve. In this respect, water is not otherwise wasted when the sprinkler is missing.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which:

FIG. 1A a side view of a sprinkler assembly according to the present invention.

FIG. 1B illustrates a cross sectional view of the sprinkler of FIG. 1A.

FIG. 2 illustrates a cross sectional view of a flow control valve, a backflow preventer valve, and a safety valve.

FIG. 3 illustrates a cross sectional view of the flow control valve in a closed position.

FIG. 4 illustrates a cross sectional view of the sprinkler with the flow control valve in an open position.

FIG. 5 illustrates a cross section view of the flow control valve in an open position.

FIG. 6 illustrates a cross sectional view of a backflow preventer valve in a closed position.

FIG. 7 illustrates a cross sectional view of a backflow preventer valve in an open position.

FIGS. 8-10 illustrate a cross sectional view of a backflow preventer valve and a safety valve.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

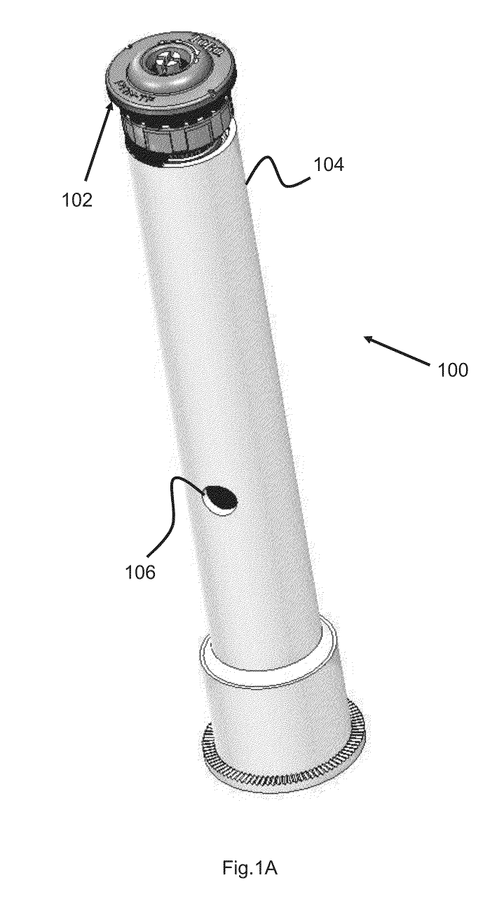

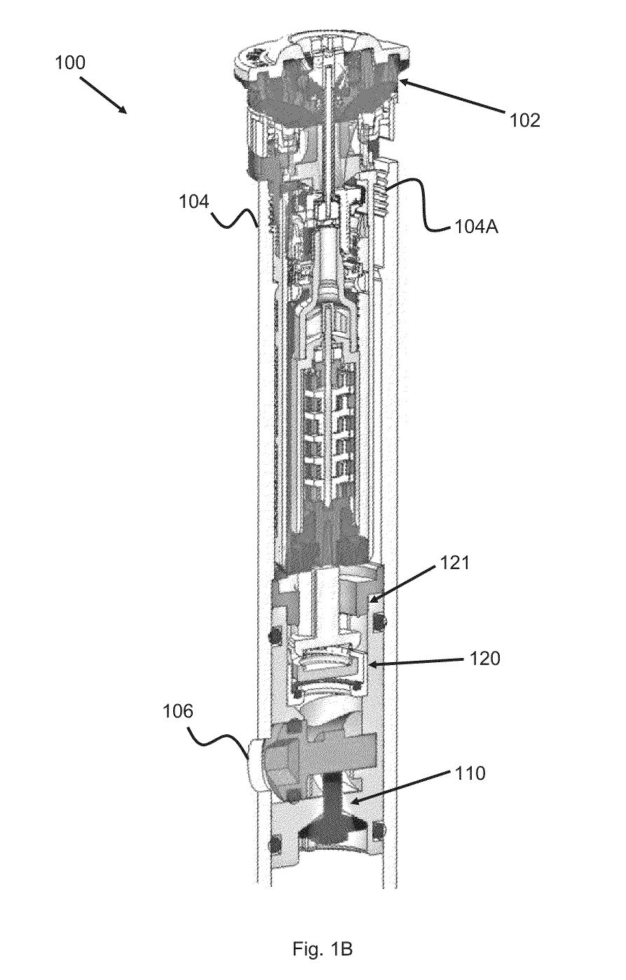

The present invention includes several different valve embodiments that block or otherwise limit water flow through a riser tube 104 of a sprinkler assembly 100, as described in further detail below. As seen in FIGS. 1A and 1B, the sprinkler assembly 100 includes a sprinkler 102 that screws onto a threaded portion 104A of the riser tube 104. Further details of one example of the sprinkler 102 can be found in U.S. Pat. No. 8,006,919 which is herein incorporated by reference.

As seen in FIG. 1B, three different valves are illustrated: a flow control valve 110, a backflow preventer valve 120, and a safety shutoff valve 121. In the embodiment of FIG. 1B, all three valves are present. However, any combinations of one or more of these valves can be used according to the present invention, some of which are discussed later in this specification.

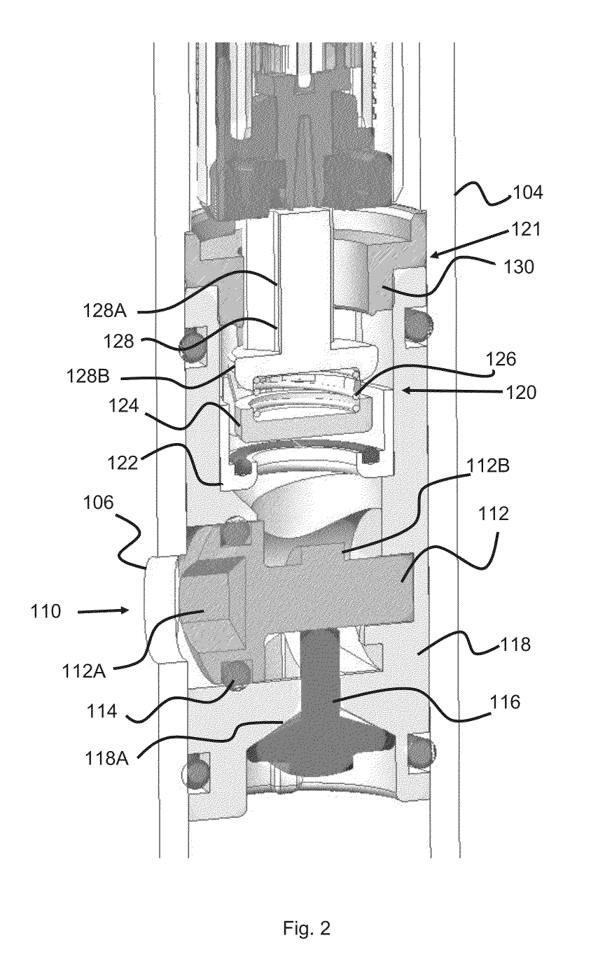

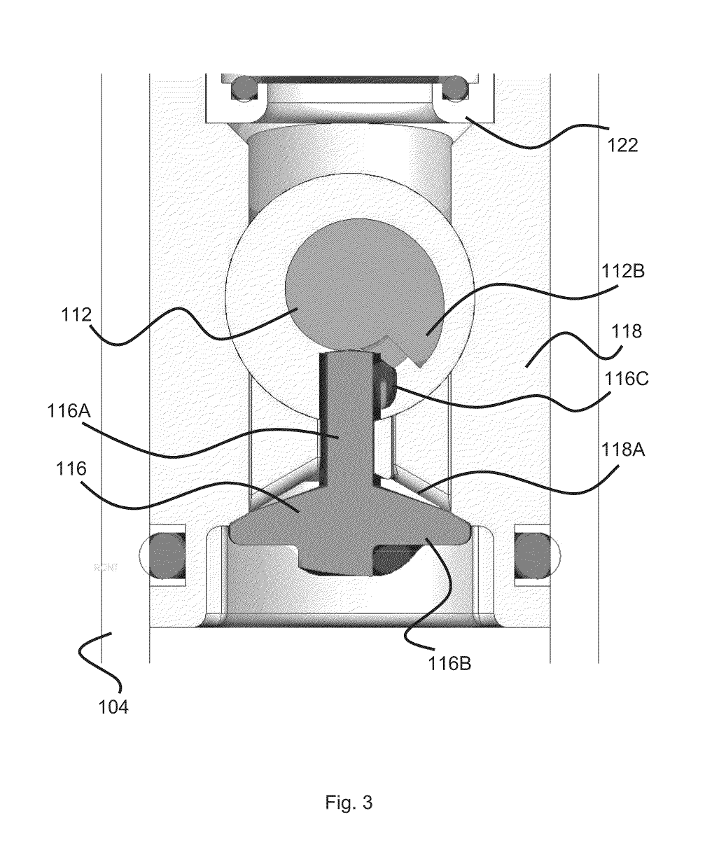

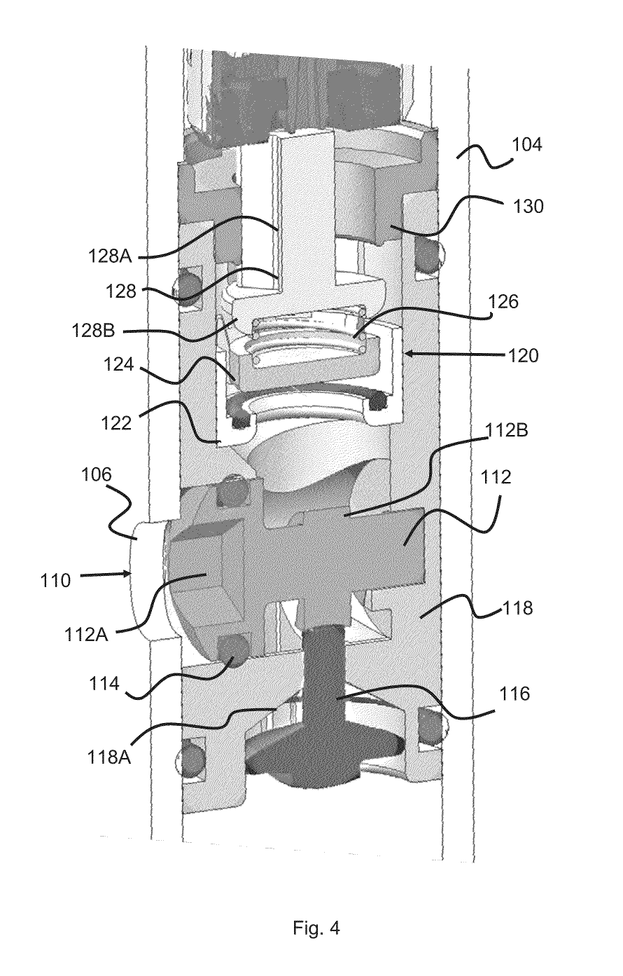

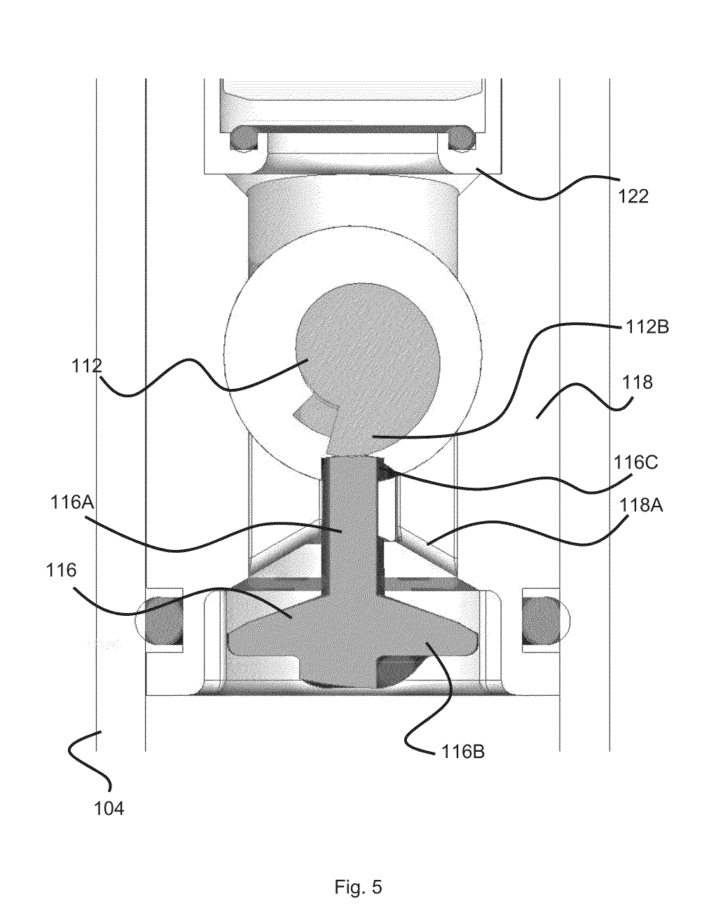

Turning first to the flow control valve 110, this valve can be seen in a closed position in FIGS. 2 and 3, and in an open position in FIGS. 4 and 5. Generally, the flow control valve 110 allows a user to insert a tool through aperture 106 to adjust how much water passes out of the sprinkler 102. In this respect, the user has more control regarding how much water the sprinkler will irrigation at any given time.

The flow control valve 110 includes a horizontal cam shaft 112 that moves a valve member 116 vertically. The cam shaft 112 includes a tool area 112A that is sized and shaped to engage a tool. To prevent water leakage around the cam shaft 112, an O-ring 114 is located around the outer circumference of the tool area 112A. The shaft 112 also includes a cam surface 112B, which increases in diameter at various radial position on the shaft 112, as best seen in FIGS. 3 and 5.

As the shaft 112 rotates, the cam surface 112B increases in size against the top of the elongated portion 116A of the valve member 116, causing the valve member 116 to move downward (FIG. 5). Since the radial portion 116B of the valve member 116 is positioned away from the valve seat surface 118A of the inner support structure 118, water passes through the valve and up into the sprinkler 102.

Rotation of the cam shaft 112 in the opposite direction decreases the size of the cam surface 112B pressing against the top of the elongated portion 116A, causing the valve member 116 to move upwards. Since the radial portion 116B of the valve member 116 is positioned against the valve seat surface 118A, water cannot pass through the valve 110. While the valve 110 is shown in an open and closed position, it should be understood that a range of positions in between the on/off positions are also possible.

In the present embodiment, the valve member 116 slides freely within the support structure 118 and further includes an enlarged portion 116C (FIG. 3) that prevents the valve member 116 from completely falling through the passage it is located in within the figures. In this respect, when no water is flowing to the valve 110, gravity pulls the valve member 116 down to its lowest, open position. However, when water flows to the valve 110, it pushes the valve member 116 upwards until it contacts the cam surface 112B, which maintains valve member 116 at a designated position, depending on the rotational position of the cam shaft 112.

Alternately, the valve member 116 can be biased upward against the cam shaft 112. For example, a spring or elastic material could be used to achieve this bias.

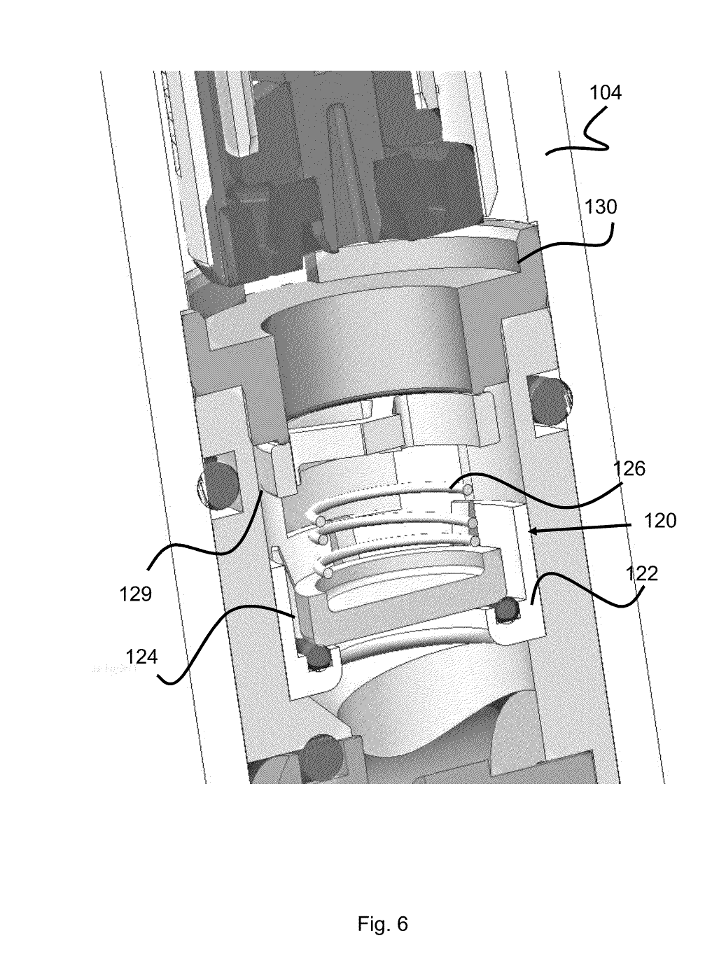

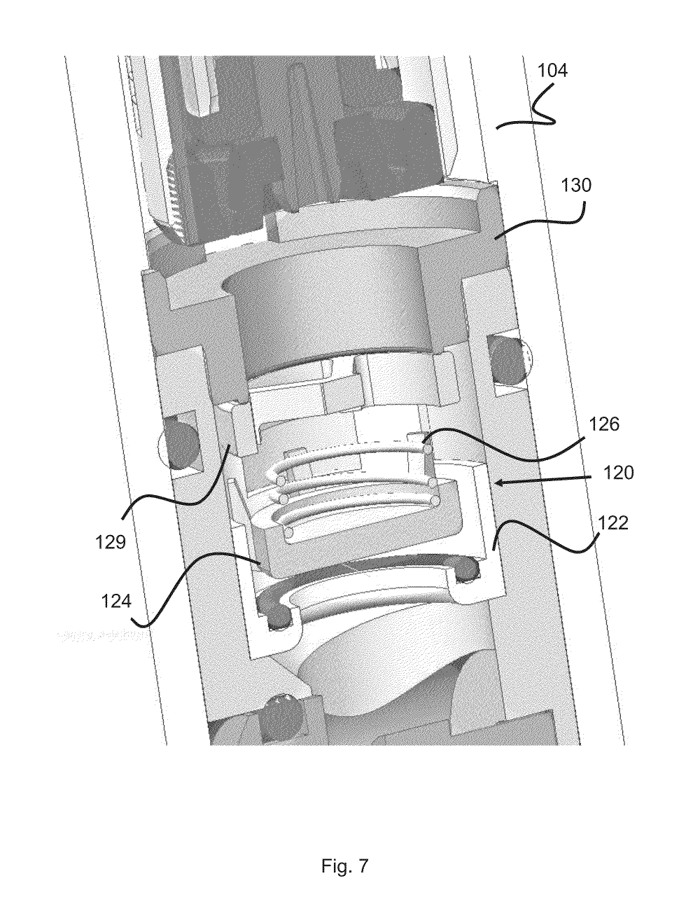

FIGS. 6 and 7 best illustrate a backflow preventer valve 120, which acts as a one-way valve, allowing water to flow up to the sprinkler 102, but not back down into the irrigation pipes. When water flow to the sprinkler 102 stops, the water remaining in the sprinkler 102 and riser 106 drops back down into the irrigation pipes quickly, which can cause dirt, debris, and water on the outside of the sprinkler 102 to be sucked into the sprinkler 102. This dirt and debris can cause damage to the moving parts of the sprinkler (e.g., turbine, gears, and other moving components). The backflow preventer valve 120 immediately closes when irrigation stops, preventing this water draining and therefore sucking from occurring. In one embodiment, the valve 120 is configured to open a pressures above about 3 psi and close at pressures lower than that value.

The backflow preventer valve 120 in FIGS. 6 and 7 includes a circular valve member 124 that is configured to move vertically against a valve seat 122. A spring 126 is located above the valve member 124, biasing the valve member 124 into the closed position against seat 122 (FIG. 6). While only a portion of the spring is shown, it can press against non-moving cross member 129 and against the top side of the valve member 124. When the downstream valve of the water supply tubes is opened and water pressure increases at the valve 120, the valve member 124 moves vertically upwards, allowing water to pass through (FIG. 7). Note that in this embodiment, the safety shutoff valve 121 is not present.

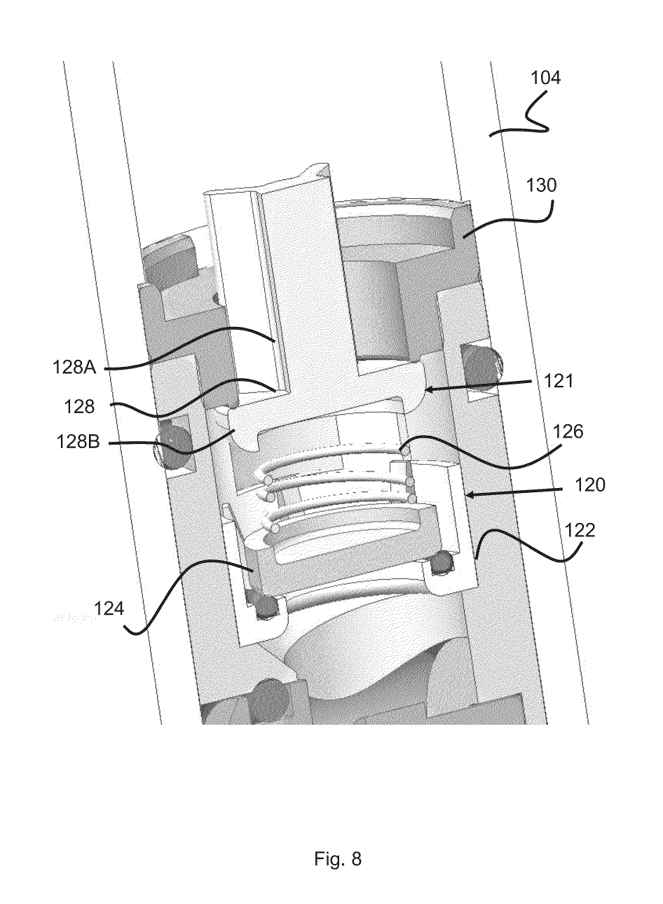

FIGS. 8-10 illustrate an embodiment that includes both the backflow preventer valve 120 and the safety shutoff valve 121. The purpose of the safety shutoff valve 121 is to remain closed when the sprinkler 102 is removed, broken, or otherwise missing from the riser 106, or when a riser plug is not present. In this respect, the valve 121 prevents wasted water and possible water damage that may otherwise occur.

The safety shutoff valve 121 includes a valve member 128 having an upper, elongated portion 128A and a lower, radially-enlarged portion 128B. The lower portion 128B is sized so as to seat against the underside of valve seat member 130 when in an elevated position. The lower portion 128B also includes a recessed area on its underside, which captures a top portion of a spring 126. The spring 126 is also captured by a second recessed portion on the upper side of valve member 124. In this respect, the spring 126 provides a downward bias force on the valve member 124 and an upward bias force on the valve member 128.

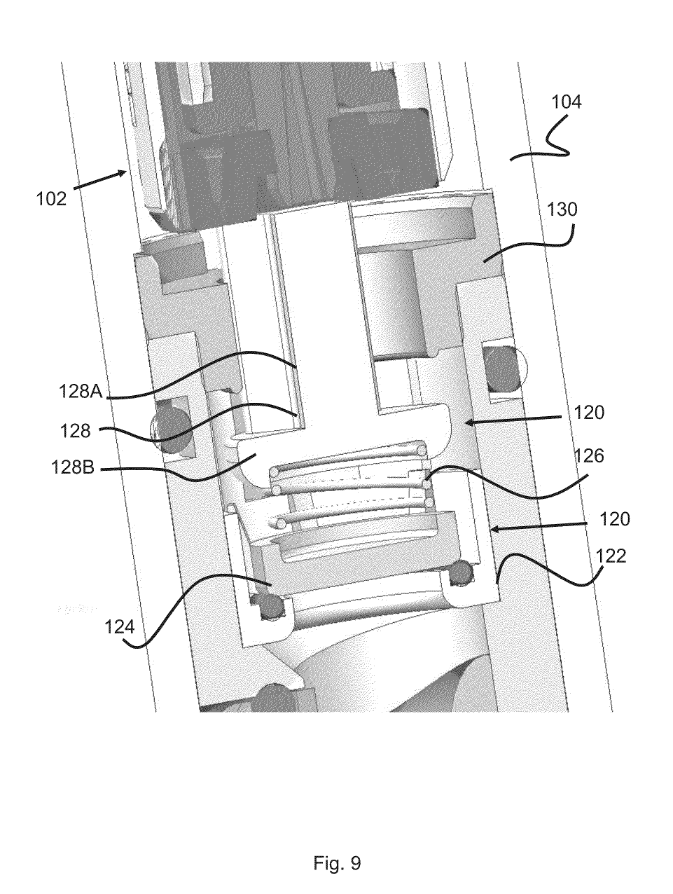

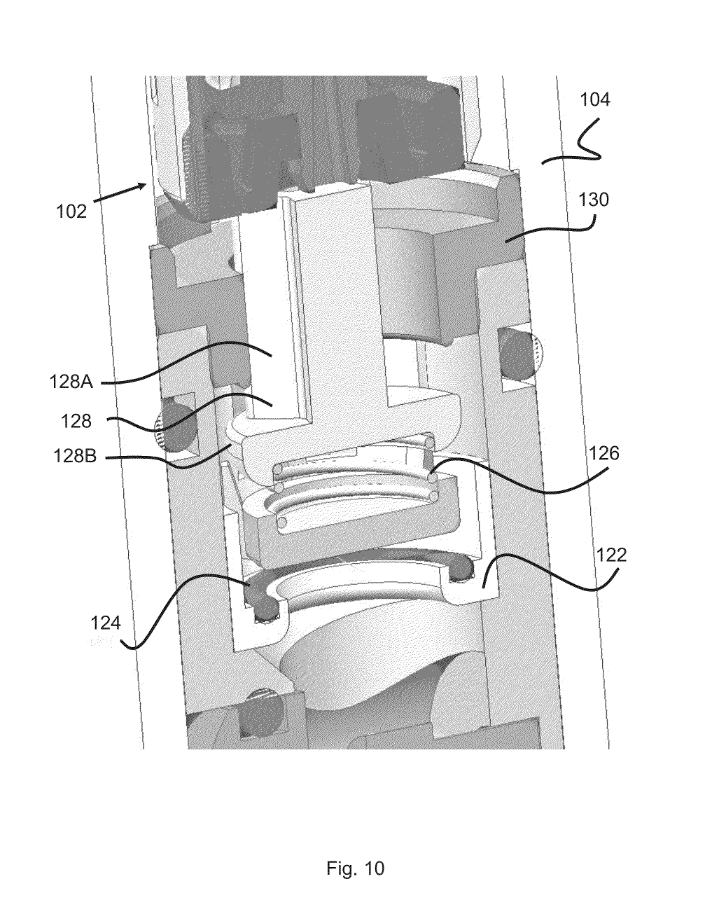

As seen in FIG. 8, when no sprinkler 102 is present but water is being delivered to the sprinkler assembly 100, the valve member 128 is pushed upward by the water pressure, closing the safety valve 121 (note, while the backflow preventer valve 130 is depicted as closed, it would otherwise open during active water pressure). FIG. 9 illustrates how, when the sprinkler 102 is present, its underside contacts the elongated portion 128A and pushes the valve member 128 downward, causing the valve 121 to be open. Since no water pressure is present in FIG. 9, the backflow preventer valve 120 remains closed. In FIG. 10, water pressure is present, causing the backflow preventer valve 120 to open, allowing water to flow through both valves 120 and 121.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A sprinkler assembly, comprising:
a sprinkler assembly tube configured to support an irrigation sprinkler;
an adjustment member disposed horizontally within said sprinkler assembly and having a first end exposed through an aperture in said sprinkler assembly tube;
a first valve member vertically moveable relative to a first valve seat;
wherein rotation of said adjustment member moves said first valve member vertically towards or away from said first valve seat.

2. The sprinkler assembly of claim 1, wherein said adjustment member further comprises a cam surface that contacts said first valve member.

3. The sprinkler assembly of claim 2, wherein at least a portion of said first valve seat is located above at least a portion of said first valve member.

4. The sprinkler assembly of claim 3, wherein said first valve member has a first closed position and a second open position in which it is positioned lower than said closed position.

5. The sprinkler of claim 1, further comprising a second valve member downwardly biased against a second valve seat.

6. The sprinkler of claim 5, further comprising a third valve member configured to be spaced apart from a third valve seat when a sprinkler is connected to said sprinkler assembly.

7. The sprinkler of claim 6, further comprising a spring that is in contact with said third valve member and said second valve member.

8. A sprinkler assembly, comprising:
a sprinkler assembly tube configured to support an irrigation sprinkler;
an adjustment member disposed within said sprinkler assembly and having a first end exposed through an aperture in said sprinkler assembly tube; said adjustment member having a cam surface;
a first valve member vertically moveable relative to a first valve seat;
wherein rotation of said adjustment member moves different portions of said cam surface against said first valve member, moving said first valve member vertically towards or away from said first valve seat.

9. The sprinkler of claim 8, wherein said adjustment member is oriented horizontally within said irrigation sprinkler.

10. The sprinkler of claim 8, wherein said first end of said adjustment member is shaped to accept a tool.

11. The sprinkler of claim 10, wherein said cam surface is a ramped surface on said adjustment member that increases in thickness along different radial locations.

12. The sprinkler of claim 10, further comprising a second valve member downwardly biased against a second valve seat.

13. The sprinkler of claim 12, further comprising a third valve member configured to be spaced apart from a third valve seat when a sprinkler is connected to said sprinkler assembly.

14. The sprinkler of claim 13, further comprising a spring that is in contact with said third valve member and said second valve member.

15. A sprinkler assembly, comprising:
a sprinkler assembly tube configured to support an irrigation sprinkler;
a first valve member downwardly biased against a first valve seat;
a second valve member located above said first valve member and below a second valve seat;
a spring located between and contacting said first valve member and said second valve member;
wherein said second valve member is positioned so as to be contactable by a sprinkler connected at a top of said sprinkler assembly tube.

16. The sprinkler of claim 15, further comprising:
an adjustment member disposed within said sprinkler assembly and having a first end exposed through an aperture in said sprinkler assembly tube; said adjustment member having a cam surface;
a third valve member vertically moveable relative to a third valve seat;
wherein rotation of said adjustment member moves different portions of said cam surface against said third valve member, moving said third valve member vertically towards or away from said third valve seat.

17. The sprinkler of claim 16, wherein said third valve member is at least partially located within an opening of said third valve seat.

18. The sprinkler of claim 15, wherein said first valve member is configured to open at a water pressure of 3 psi or higher.
